(19) United States
(12) Patent Application Publication
(10) Pub. No.: US 2026/0212878 A1
(43) Pub. Date: Jul. 23, 2026

(54) ECHO ELIMINATING DEVICE WITHOUT REFERENCE LOOP AND METHOD THEREOF

(71) Applicant: ESPRESSIF SYSTEMS (SHANGHAI) CO., LTD., Shanghai (CN)

(72) Inventor: Xiaozheng SHEN, Shanghai (CN)

(21) Appl. No.: 19/157,326

(22) PCT Filed: Feb. 8, 2024
(86) PCT No.: PCT/CN2024/076994

§ 371 Date: Aug. 15, 2025

(30) Foreign Application Priority Data
Feb. 15, 2023 (CN) 202310121538.7

(51) Int. Cl. G10L 21/0232; G10L 21/0208; G10L 21/0216; G10L 21/028

(52) U.S. Cl. CPC G10L 21/0232; G10L 21/028; G10L 2021/02082; G10L 2021/02166

(57) ABSTRACT

The present disclosure provides an echo cancellation apparatus without a reference loop, which includes a fixed beamforming module configured to fix a multi-channel signal acquired by a speech acquisition unit into a plurality of first beams, superimpose the plurality of first beams and output a target signal; a blocking matrix module configured to input the multi-channel signal acquired by the speech acquisition unit into a blocking matrix for preprocessing to output a non-target signal; a cancellation module configured to perform cancellation between the target signal and the non-target signal and output a multi-beam first signal; a multi-channel dereverberation module configured to perform dereverberation on the multi-channel signal acquired by the speech acquisition unit and output a multi-channel second signal; a blind source separation module configured to perform blind source separation on the multi-channel second signal to output a multi-channel third signal, perform signal-to-noise ratio calculation on each channel of the multi-channel third signal in the frequency domain, and determine a weight of each channel of the multi-channel third signal; and a mapping module configured to map the weights to the multi-beam first signal and output a mapped multi-channel frequency-domain fourth signal.

### TECHNICAL FIELD

The present disclosure relates to the field of far-field speech interaction, and in particular to an echo cancellation apparatus and method without a reference loop.

### BACKGROUND

In recent years, far-field speech interaction has greatly improved the intelligence of home appliances, vehicle-mounted systems, and ticket machines. Speech interaction is also the most natural way of interaction. At the same time, in order to achieve better efficiency in working from home, conference systems have been rapidly deployed on more smart devices. Whether in far-field speech interaction or conference systems, echo cancellation technology is the core algorithm module. Its function is to solve the problem of interruption during the playback of speech interaction equipment, and the problem that the sound of the conference venue in the conference system is transmitted to the other venue, played out by the speaker, and then enters the microphone again and is transmitted back to the venue. Echo cancellation generally estimates the echo path through an adaptive filtering algorithm, and then subtracts the target echo from the noisy speech obtained by the microphone, making speech interaction more efficient and meetings more realistic.

Since the sound played by the smart device's own speaker is transmitted back to the microphone, the user's speech signals such as commands cannot be clearly and accurately recognized. To address this problem, the existing art generally adopts a technical solution with a reference loop to eliminate echoes, that is, a reference signal emitted by a speaker is acquired through the reference loop, and based on this, echo cancellation is performed on the speech signal acquired by the microphone. For example, Chinese patent CN213211700U discloses an echo cancellation device, which includes: a control unit, an audio signal processing unit, an audio playback unit, an echo cancellation unit, a reference signal acquisition unit, a speech signal acquisition unit, and an analog-to-digital conversion unit. The reference signal acquisition unit is arranged within a preset distance range of the audio playback unit, and the echo cancellation is performed by inputting the acquired reference signal and the speech signal of the target speaker obtained by the speech signal acquisition unit into the echo cancellation unit. On the one hand, this method relies on a reference loop, and on the other hand, it also has the problem of easily weakening the target speaker's speech, especially when the device's audio playback unit is not in playback mode, the signal obtained by the reference signal acquisition unit mainly comes from the target speaker. Therefore, in this case, the clarity of the target speaker's speech signal will be reduced to a certain extent, and the echo cancellation module may even completely suppress the target speech.

Chinese patent CN209962694U discloses an echo cancellation circuit and electroacoustic device, including a power amplifier module, a speaker, a microphone, an echo cancellation module and a filter circuit. The filtering circuit is configured to acquire the speech reference signal from the power amplifier module and filter the high-frequency noise therein. The microphone receives a mixed speech signal of the echo signal emitted by the speaker and the speech signal emitted by the user. Furthermore, the echo cancellation module performs echo cancellation based on the speech reference signal acquired from the filter circuit and the mixed speech signal acquired from the microphone. This technical solution mainly reduces the noise of the reference signal obtained by hardware through a filtering circuit to improve the effect of echo cancellation. However, although the filtering circuit can solve the problem of target speech suppression to a certain extent, due to the miniaturization and cost reduction of power amplifier modules and speakers, the loop reference signal obtained by the filtering circuit is very different from the actual nonlinear echo generated, and the performance of the echo cancellation algorithm is greatly reduced.

Chinese patent CN104822001B discloses a method and apparatus for synchronous control of echo cancellation data, comprising: estimating a sound card delay value; waiting until a difference between a length of a reference audio buffer queue and a length of a near-end audio buffer queue is greater than or equal to an audio data length corresponding to the sound card delay value; extracting data from the heads of the reference audio buffer queue and the near-end audio buffer queue on an audio frame basis for echo cancellation; obtaining a relative delay value generated by the echo cancellation process; and adjusting the sound card delay based on the relative delay value. The core of this solution is to obtain the time delay between the hardware reference loop and the microphone's audio data acquisition, and to solve the problem of asynchrony caused by clock jitter affecting the echo cancellation effect through delay estimation. However, when the external noise is high, it is easy to cause inaccurate estimation.

In summary, it can be seen that the current mainstream technical solutions still rely on the reference loop to acquire references to perform echo cancellation on the mixed speech acquired by the speech acquisition module, and its echo cancellation performance needs to be improved.

### SUMMARY

In view of the above problems, the present disclosure provides an echo cancellation apparatus and method without a reference loop. A novel echo cancellation method is proposed through the design of microphone array acoustic structure and innovation of algorithm. The present disclosure does not require delay estimation of reference signal, can handle nonlinear echo well, and does not require complex reference loop design.

According to a first aspect of the present disclosure, there is provided an echo cancellation apparatus without a reference loop, including: a fixed beamforming module configured to fix a multi-channel signal acquired by a speech acquisition unit into a plurality of first beams, superimpose the plurality of first beams and output a target signal; a blocking matrix module configured to input the multi-channel signal acquired by the speech acquisition unit into a blocking matrix for preprocessing to output a non-target signal; a cancellation module configured to perform cancellation between the target signal and the non-target signal generated based on the multi-channel signal acquired by the speech acquisition unit and output a multi-beam first signal; a multi-channel dereverberation module configured to perform dereverberation on the multi-channel signal acquired by the speech acquisition unit and output a multi-channel second signal; a blind source separation module configured to perform blind source separation on the multi-channel second signal to output a multi-channel third signal, perform signal-to-noise ratio calculation on each channel of the multi-channel third signal in the frequency domain, and determine a weight of each channel of the multi-channel third signal; and a mapping module configured to map the weights to the multi-beam first signal and output a mapped multi-channel frequency-domain fourth signal.

As an embodiment of the present disclosure, the cancellation module performing cancellation between the target signal and the non-target signal and outputting a multi-beam first signal includes: (1) performing cancellation between the target signal and non-target signal according to the following formula: ERR=MIC−w*REF, wherein ERR is a residual signal, MIC is the target signal, w is a filter parameter, REF is the non-target signal; (2) the residual signal ERR includes K single beam first signals B₁, B₂, . . . until B_{K}, performing framing on each single-beam first signal in the residual signal to obtain T sub-frames, and performing Fourier transform on each of the sub-frames to obtain the multi-beam first signal in the frequency domain

$${B}_{k t f}^{( 1 )} ,$$

wherein k is the beam number, k=1, 2, . . . , K, K is the number of beams in the target signal, t is the frame number of the corresponding sub-frame, t=1, 2, . . . , T, f is the frequency point number, f=1, 2, . . . , F.

As an embodiment of the present disclosure, the blind source separation module is configured to calculate the signal-to-noise ratio according to the following formula to obtain the signal-to-noise ratio SNR_{ntf} of each channel of the multi-channel third signal:

$${SNR}_{n t f} = {B}_{n t f}^{( 2 )} / {( {S}_{n t f} - {B}_{n t f}^{( 2 )} )}^{2} ,$$

wherein S_{ntf} is the multi-channel second signal output in the frequency domain by the multi-channel dereverberation module,

$${B}_{n t f}^{( 2 )}$$

is the multi-channel third signal obtained by performing blind source separation on the multi-channel second signal through the blind source separation module, wherein n is the microphone number, n=1, 2, . . . , N, N is the number of microphones in the speech acquisition unit, t is the frame number of the corresponding sub-frame, t=1, 2, . . . , T, f is the frequency point number, f=1, 2, . . . , F.

As an embodiment of the present disclosure, the blind source separation module is configured to determine the weight G_{ntf} of each channel of the multi-channel third signal according to the following formula: G_{ntf}=SNR_{ntf}/(1+SNR_{ntf}), wherein SNR_{ntf} is the signal-to-noise ratio of each third signal, n is the microphone number, n=1, 2, . . . , N, N is the number of microphones in the speech acquisition unit, t is the frame number of the corresponding sub-frame, t=1, 2, . . . , T, f is the frequency point number, f=1, 2, . . . , F.

As an embodiment of the present disclosure, the mapping module is configured to N sets of weights G

$${B}_{k t f}^{( 1 )}$$

according to the following formula, to obtain the mapped multi-channel frequency-domain fourth signal E, wherein:

$${E}_{m t f} = {G}_{ntf} * {B}_{k t f}^{( 1 )} ,$$

wherein E_{mtf} is the m^{th} channel of the multi-channel frequency domain fourth signal, m=1, 2, . . . , M, M=K*N, K is the number of beams in the target signal, N is the number of microphones in the speech acquisition unit; G_{ntf} is the weight of the n^{th} channel of the multi-channel third signal,

$$n = 1 , 2 , … , N ; {B}_{k t f}^{( 1 )}$$

is k^{th} beam of the multi-beam first signal, k=1, 2, . . . , K; t is the frame number of the corresponding sub-frame, t=1, 2, . . . , T, f is the frequency point number, f=1, 2, . . . , F. The mapping module is further configured to perform an inverse Fourier transform operation on the multi-channel frequency-domain fourth signal to obtain a multi-channel time-domain fourth signal eₘ, wherein m=1, 2, . . . , M.

As an embodiment of the present disclosure, the apparatus further includes: a wake-up engine configured to score each channel of the multi-channel time-domain fourth signal to obtain scores respectively, determine a Z-channel time-domain fourth signal with scores greater than a wake-up threshold, and determine a time-domain channel with the highest energy of the Z-channel time-domain fourth signal, where Z is greater than or equal to 1; the wake-up engine is also configured to output the time-domain channel with the highest energy; and a recognition engine configured to obtain the time-domain channel with the highest energy from the wake-up engine to perform speech recognition and output the recognized speech.

According to a second aspect of the present disclosure, there is provided an echo cancellation method without a reference loop, which includes the following steps: fixing a multi-channel signal acquired by a speech acquisition unit into a plurality of first beams, superimposing the plurality of first beams and outputting a target signal; inputting the multi-channel signal acquired by the speech acquisition unit into a blocking matrix for preprocessing to output a non-target signal; performing cancellation between the target signal and the non-target signal and outputting a multi-beam first signal; performing dereverberation on the multi-channel signal acquired by the speech acquisition unit, and outputting a multi-channel second signal; performing blind source separation on the multi-channel second signal to obtain a multi-channel third signal, performing signal-to-noise ratio calculation on each channel of the multi-channel third signal in the frequency domain, and determining a weight of each channel of the multi-channel third signal; and mapping the weights to the multi-beam first signal and outputting a mapped multi-channel frequency-domain fourth signal.

As an embodiment of the present disclosure, performing cancellation between the target signal and the non-target signal and outputting the multi-beam first signal includes: (1) performing cancellation between the target signal and the non-target signal according to the following formula: ERR=MIC−w*REF, wherein ERR is a residual signal, MIC is the target signal, w is a filter parameter, REF is the non-target signal; (2) the residual signal ERR includes K single beam first signals B₁, B₂, . . . until B_{K}, performing framing on each single-beam first signal in the residual signal to obtain T sub-frames, and performing Fourier transform on each of the sub-frames to obtain the multi-beam first signal in the frequency domain

$${B}_{k t f}^{( 1 )} ,$$

wherein k is the beam number, k=1, 2, . . . , K, K is the number of beams in the target signal, t is the frame number of the corresponding sub-frame, t=1, 2, . . . , T, f is the frequency point number, f=1, 2, . . . , F.

As an embodiment of the present disclosure, performing signal-to-noise ratio calculation on each channel of the multi-channel third signal in the frequency domain further includes: performing the signal-to-noise ratio calculation according to the following formula to obtain the signal-to-noise ratio SNR_{ntf} of each third signal in the multi-channel third signal:

$${SNR}_{n t f} = {B}_{n t f}^{( 2 )} / {( {S}_{n t f} - {B}_{n t f}^{( 2 )} )}^{2} ,$$

wherein S_{ntf} is the multi-channel second signal output by the multi-channel dereverberation module in the frequency domain,

$${B}_{n t f}^{( 2 )}$$

is the multi-channel third signal obtained by performing blind source separation on the multi-channel second signal through the blind source separation module, wherein n is the microphone number, n=1, 2, . . . , N, N is the number of microphones in the speech acquisition unit, t is the frame number of the corresponding sub-frame, t=1, 2, . . . , T, f is the frequency point number, f=1, 2, . . . , F.

As an embodiment of the present disclosure, determining the weight G_{ntf} of each channel of the multi-channel third signal further includes: determining the weight of each channel of the multi-channel third signal according to the following formula: G_{ntf}=SNR_{ntf}/(1+SNR_{ntf}), wherein SNR_{ntf} is the signal-to-noise ratio of each third signal, n is the microphone number, n=1, 2, . . . , N, N is the number of microphones in the speech acquisition unit, t is the frame number of the corresponding sub-frame, t=1, 2, . . . , T, f is the frequency point number, f=1, 2, . . . , F.

As an embodiment of the present disclosure, mapping the weights to the multi-beam first signal and outputting a mapped multi-channel frequency-domain fourth signal further includes: mapping N sets of weights G_{ntf} to K sets of multi-beam first signals

$${B}_{k t f}^{( 1 )}$$

according to the following formula, to obtain the mapped multi-channel frequency-domain fourth signal E, wherein:

$${E}_{m t f} = {G}_{n t} * {B}_{k t f}^{( 1 )} ,$$

wherein E_{mtf} is the m^{th} frequency-domain channel of the multi-channel frequency domain fourth signal, m=1, 2, . . . , M, M=K*N, K is the number of beams in the target signal, N is the number of microphones in the speech acquisition unit; G_{ntf} is the weight of the n^{th} channel of the multi-channel third signal,

$$n = 1 , 2 , … , N ; {B}_{k t f}^{( 1 )}$$

is k^{th} single beam first signal of the multi-beam first signal, k=1, 2, . . . , K; t is the frame number of the corresponding sub-frame, t=1, 2, . . . , T, f is the frequency point number, f=1, 2, . . . , F. More preferably, in step S212, the method further comprises performing an inverse Fourier transform operation on the multi-channel frequency-domain fourth signal to obtain a multi-channel time-domain fourth signal eₘ, wherein m=1, 2, . . . , M.

As an embodiment of the present disclosure, the method further includes: after outputting the mapped multi-channel frequency-domain fourth signal, scoring each channel of the multi-channel time-domain fourth signal to obtain scores respectively, determine a Z-channel time-domain fourth signal with scores greater than a wake-up threshold, and determine a time-domain channel with the highest energy of the Z-channel time-domain fourth signal, where Z is greater than or equal to 1; and outputting the time-domain channel with the highest energy; and obtaining the time-domain channel with the highest energy to perform speech recognition and output the recognized speech.

The present disclosure utilizes the spatial independence of the speech acquisition module and the audio playback module in the acoustic structure, applies the beamforming method, and combines the blind source separation method in statistics. Without the need to obtain a reference signal from the audio playback module or perform delay estimation on the reference signal, the present disclosure can effectively eliminate nonlinear echoes, thereby obtaining a clear target speech, realizing an echo cancellation method without a reference loop.

### BRIEF DESCRIPTION OF THE DRAWINGS

In order to more clearly illustrate the embodiments of the present disclosure or the technical solutions in the prior art, the following briefly introduces the drawings required for use in the embodiments or the description of the prior art. The drawings described below are only some embodiments of the present disclosure. For those skilled in the art, other drawings can be obtained based on these drawings without creative work.

FIG. 1 is a schematic diagram showing an echo cancellation apparatus without a reference loop according to the present disclosure;

FIG. 2 is a schematic flow chart showing an echo cancellation method without a reference loop according to an embodiment of the present disclosure;

FIG. 3 is a schematic diagram showing a hardware design of an echo cancellation apparatus according to an embodiment of the present disclosure;

FIG. 4 is a schematic diagram showing an echo cancellation apparatus according to a specific example of the present disclosure;

FIG. 5A is a schematic diagram showing original noisy data according to an embodiment of the present disclosure;

FIG. 5B is a schematic diagram showing clean speech data output after echo cancellation according to an embodiment of the present disclosure.

### DETAILED DESCRIPTION

The technical solutions in the embodiments of the present disclosure will be clearly and completely described below in conjunction with the accompanying drawings in the embodiments of the present disclosure. Obviously, the described embodiments are only part of the embodiments of the present disclosure, rather than all the embodiments. Based on the embodiments of the present disclosure, all other embodiments obtained by those skilled in the art without making any creative work shall fall within the scope of protection of the present disclosure.

First, the application scenario of the present disclosure is introduced. The present disclosure is mainly aimed at smart home scenarios, where the space where the smart home is located is usually large, which is prone to echo interference such as reverberation sound and reflected sound. In addition, since there is no sound-absorbing material in the usual environment, there will be very strong interference when implementing speech recognition. For example, compared with speech recognition in a vehicle environment, speech recognition in a smart home scenario will face greater technical difficulties.

Smart home devices, such as smart speakers or smart TVs, usually have an audio playback unit and a speech acquisition unit located in separate locations. For example, in smart speaker devices, the speaker is usually arranged in the lower middle part of the speaker body facing the base, and a sound guide cone is arranged on the base to make the sound waves hit the sound guide cone and diffuse into the space, while the annular microphone array serving as the speech acquisition unit is arranged on the top of the smart speaker to facilitate sound pickup. As another example, smart TVs and other devices with screens usually have speakers installed on the side of the TV, creating a stereo surround acoustic experience through multiple playback units, while the speech acquisition unit is installed directly in front of the screen so that users can stand in front of the screen for far-field speech interaction when speech interaction is needed. Therefore, the acoustic design of such smart home devices meets the spatial independence of the sound source, that is, the speech acquisition unit is not easily interfered with by the audio playback unit, thus creating favorable conditions for echo cancellation.

### Specific Embodiment 1

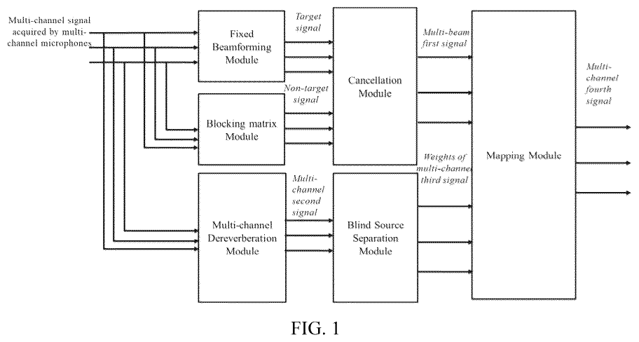

As shown in FIG. 1, a schematic diagram of an echo cancellation apparatus without a reference loop according to the present disclosure is illustrated. The echo cancellation apparatus includes a fixed beamforming module, a blocking matrix module, a cancellation module, a multi-channel dereverberation module, a blind source separation module and a mapping module.

The fixed beamforming module is configured to fix a multi-channel signal acquired by the speech acquisition unit into a plurality of first beams, superimpose the a plurality of first beams and output a target signal.

By way of example and not limitation, the speech acquisition unit is a microphone array including a plurality of microphones. It should be noted that the speech acquisition unit in the present disclosure may be a single microphone array.

By way of example and not limitation, the fixed beamforming module combines and processes the multi-channel signal (such as a multi-channel microphone signal) acquired by the speech acquisition unit to suppress interference signals in non-target directions and enhance sound signals in the target direction. By adjusting the filter coefficients of each microphone and performing weighted summation and filtering on the output signals of each microphone, the beams of the sound signal are superimposed as much as possible. The signal in the direction of the target speaker obtains constructive interference, while the signals at the angles of other non-target speakers obtain destructive interference, ultimately outputting a speech signal in the desired direction and forming a multi-beam target signal.

The blocking matrix module is configured to input the multi-channel signal acquired by the speech acquisition unit into the blocking matrix for preprocessing to output a non-target signal.

By way of example and not limitation, the blocking matrix is configured to block the multi-channel signal acquired by the speech acquisition unit to obtain a non-target signal containing noise and interference.

The cancellation module is configured to perform cancellation between the target signal and the non-target signal and output a multi-beam first signal.

Preferably, the cancellation module performs cancellation between the target signal and the non-target signal and outputs the multi-beam first signal, specifically including: (1) performing cancellation between the target signal and non-target signal according to the following formula: ERR=MIC−w*REF, wherein ERR is a residual signal, MIC is the target signal, w is a filter parameter, REF is the non-target signal; (2) the residual signal ERR includes K single beam first signal B₁>B₂, . . . until B_{K}, performing framing on each single-beam first signal in the residual signal to obtain T frames, and performing Fourier transform on each of the frames to obtain the multi-beam first signal in the frequency domain

$${B}_{k t f}^{( 1 )} ,$$

wherein k is the beam number, k=1, 2, . . . , K, K is the number of beams in the target signal, t is the frame number of the corresponding sub-frame, t=1, 2, . . . , T, f is the frequency point number, f=1, 2, . . . , F.

By way of example and not limitation, the number of beams in the target signal is a preset value. Although the greater the number of beams, the better the final speech processing effect, considering the computational overhead, a compromise value needs to be selected as the preset number of beams based on actual conditions.

By way of example and not limitation, a Fast Fourier Transform (FFT) may be performed on each of the sub-frames.

By way of example and not limitation, the cancellation module is an adaptive noise canceller based on adaptive filtering.

Exemplarily, a generalized sidelobe canceller or a transfer function generalized sidelobe canceller may be used to implement the above fixed beamforming module, blocking matrix module, and cancellation module.

Exemplarily, a generalized sidelobe canceller may be used to implement the above fixed beamforming module, blocking matrix module and cancellation module, wherein the upper branch consists of a fixed beamformer with delay summation, which projects the received signal into a constrained subspace, in the expectation that only the target signal of pure desired speech passes through; the lower branch consists of a blocking matrix and an adaptive canceller, which projects the received signal into a minimum variance subspace, in the expectation that only the non-target signal of noise passes through, and performs cancellation between the non-target signal with the target signal of the upper branch during the adaptive filtering process to obtain a multi-beam first signal.

Exemplarily, a transfer function sidelobe canceller may be used to implement the above-mentioned fixed beamforming module, blocking matrix module, and cancellation module, wherein the fixed beamformer is configured to align the received signal components; the blocking matrix is configured to block the target signal to obtain the non-target signal of the noise, and the multi-channel adaptive noise canceller uses the non-target signal of the noise to eliminate the noise in the output of the fixed beamformer.

The multi-channel dereverberation module is configured to perform dereverberation on multi-channel signal acquired by the speech acquisition unit and output a multi-channel second signal in the frequency domain.

By way of example and not limitation, a multi-channel dereverberation module is configured to remove the effect of reverberation from a sound. Exemplarily, the multi-channel dereverberation module may utilize a dereverberation method based on a statistical model, a dereverberation method based on LPC (Linear Predictive Coding), or a dereverberation method based on an eigenvalue decomposition method.

By way of example and not limitation, the multi-channel second signal output by the multi-channel dereverberation module is denoted as S_{ntf}, wherein n is the microphone number, n=1, 2, . . . , N, N is the number of microphones in the speech acquisition unit, t is the frame number of the corresponding sub-frame, t=1, 2, . . . , T, f is the frequency point number, f=1, 2, . . . , F.

The blind source separation module is configured to perform blind source separation on the multi-channel second signal to obtain a multi-channel third signal, perform signal-to-noise ratio calculation on each channel of the multi-channel third signal in the frequency domain, and determine a weight of each channel of the multi-channel third signal. By way of example and not limitation, this solution uses the blind source separation module as a post-processing part in the echo cancellation apparatus, thereby achieving further suppression of residual echo.

Preferably, the blind source separation module calculates the signal-to-noise ratio by the following formula to obtain the signal-to-noise ratio SNR_{ntf} of each channel of the multi-channel third signal:

$${SNR}_{n t f} = {B}_{n t f}^{( 2 )} / {( {S}_{n t f} - {B}_{n t f}^{( 2 )} )}^{2} ,$$

wherein S_{ntf} is the multi-channel second signal output in the frequency domain by the multi-channel dereverberation module,

$${B}_{n t f}^{( 2 )}$$

is a multi-channel third signal obtained by performing blind source separation on the multi-channel second signal through the blind source separation module, wherein n is the microphones number, n=1, 2, . . . , N, N is the number of microphones in the speech acquisition unit, t is the frame number of the corresponding sub-frame, t=1, 2, . . . , T, f is the frequency point number, f=1, 2, . . . , F.

By way of example and not limitation, the blind source separation module uses a statistical method to perform blind source separation on the multi-channel second signal to obtain a multi-channel third signal in the frequency domain. The blind source separation module is also called the BSS (Blind Signal Separation) module. Exemplarily, the blind source separation module may use an ILRMA (Independent Low-Rank Matrix Analysis) method, an IVA independent vector analysis method, an ICA independent component analysis method, or the like to perform blind source separation on the multi-channel second signal.

Further preferably, the blind source separation module determines the weight G_{ntf} of each channel of the multi-channel third signal by the following formula:

$${G}_{n t f} = {SNR}_{n t f} / ( 1 + {SNR}_{n t f} )$$

wherein SNR_{ntf} is the signal-to-noise ratio of each channel of the multi-channel third signal, n is the microphone number, n=1, 2, . . . , N, Nis the number of microphones in the speech acquisition unit, tis the frame number of the corresponding sub-frame, t=1, 2, . . . , T, f is the frequency point number, f=1, 2, . . . , F.

The mapping module is configured to map the weights output by the blind source separation module to the multi-beam first signal, and output the mapped multi-path frequency domain fourth signal.

Preferably, the mapping module uses the following formula to respectively map the N sets of weights G_{ntf} output from the blind source separation module to the K sets of multi-beam first signal output from the cancellation module

$${B}_{k t f}^{( 1 )} ,$$

to obtain the mapped multi-channel frequency domain fourth signal E:

$${E}_{m t f} = {G}_{n t} * {B}_{k t f}^{( 1 )} ,$$

wherein E_{mtf} is the m^{th} frequency-domain channel of the multi-channel frequency domain fourth signal, m=1, 2, . . . , M, M=K*N, K is the number of beams in the target signal, N is the number of microphones in the speech acquisition unit; G_{ntf} is the weight of the n^{th} channel of the multi-channel third signal, n=1, 2, . . . , N;

$${B}_{k t f}^{( 1 )}$$

is k^{th} single beam first signal of the multi-beam first signal, k=1, 2, . . . , K; t is the frame number of the corresponding sub-frame, t=1, 2, . . . , T, f is the frequency point number, f=1, 2, . . . , F.

By way of example and not limitation, since the signal output by the blind source separation module may have an amplitude scaling problem, for example, the output of the blind source separation module may have a large amplitude difference from the original signal, the mapping module maps the weights G_{ntf} onto the multi-beam first signal, to enhance the output frequency domain speech signal and improve the signal-to-noise ratio of the final output signal.

Preferably, the mapping module is further configured to perform an inverse fast Fourier transform (IFFT) operation on the multi-channel frequency-domain fourth signal to obtain the multi-channel time-domain fourth signal eₘ, wherein m=1, 2, . . . , M.

Preferably, the echo cancellation apparatus according to the embodiment of the present disclosure further includes a wake-up engine. The wake-up engine is configured to score each channel of the multi-channel time-domain fourth signal to obtain scores respectively, determine a Z-channel time domain fourth signal with scores greater than a wake-up threshold, and determine a time domain channel with the highest energy of the Z-channel time domain fourth signal, where Z is greater than or equal to 1. The wake-up engine is also configured to output the time-domain channel with the highest energy.

By way of example and not limitation, the wake-up engine is configured to calculate the energy of each channel of the Z-channel time-domain fourth signal with scores greater than the wake-up threshold, and determine the time-domain channel with the highest energy, which is the signal with the highest signal-to-noise ratio.

Preferably, the echo cancellation apparatus according to the embodiment of the present disclosure further includes a recognition engine. The recognition engine is configured to obtain the time-domain channel with the highest energy from the wake-up engine to perform speech recognition and output the recognized speech.

By way of example and not limitation, the recognition engine may be an automatic speech recognition (ASR) engine.

By way of example and not limitation, for the intelligent conference system, it is not necessary to input the signal output by the wake-up engine into the recognition engine.

According to the technical solution of the present disclosure, the performance of the echo cancellation algorithm can be effectively improved by outputting a multi-channel signal through a mapping method. On the other hand, the blind source separation module in the technical solution of the present disclosure does not need to estimate the variance in blind source separation through preprocessing, and can achieve good separation effects without additional parameters. By improving the signal-to-noise ratio of the blind source separation module input and applying the mapping module, better performance can be achieved.

### Specific Embodiment 2

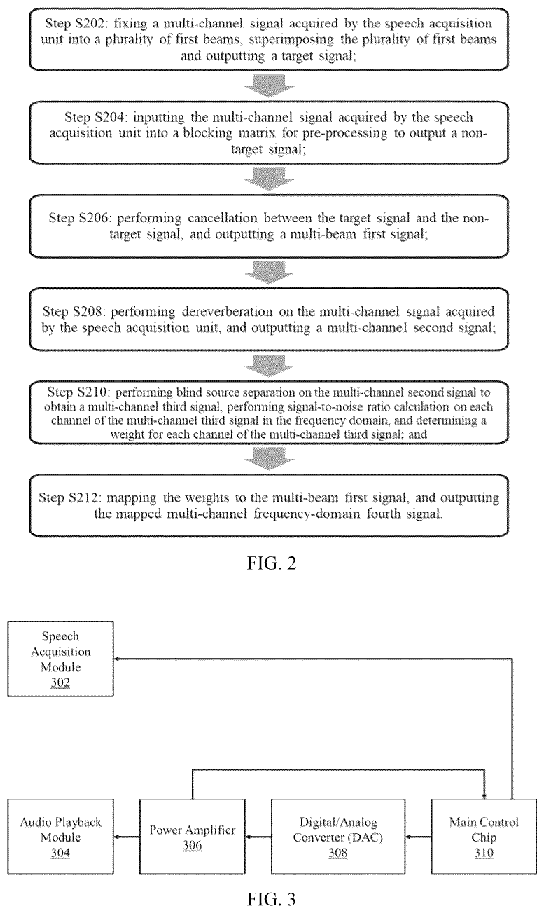

FIG. 2 is a flow chart showing an echo cancellation method without a reference loop according to an embodiment of the present disclosure, which includes the following steps.
Step S202: fixing a multi-channel signal acquired by the speech acquisition unit into a plurality of first beams, superimposing the plurality of first beams and outputting a target signal;
Step S204: inputting the multi-channel signal acquired by the speech acquisition unit into a blocking matrix for pre-processing to output a non-target signal;
Step S206: performing cancellation between the target signal and the non-target signal, and outputting a multi-beam first signal;
Step S208: performing dereverberation on the multi-channel signal acquired by the speech acquisition unit, and outputting a multi-channel second signal;
Step S210: performing blind source separation on the multi-channel second signal to obtain a multi-channel third signal, performing signal-to-noise ratio calculation on each channel of the multi-channel third signal in the frequency domain, and determining a weight for each channel of the multi-channel third signal; and
Step S212: mapping the weights to the multi-beam first signal, and outputting the mapped multi-channel frequency-domain fourth signal.

Preferably, in step S206, it further includes: (1) performing cancellation between the target signal and the non-target signal according to the following formula: ERR=MIC−w*REF, wherein ERR is a residual signal, MIC is the target signal, w is a filter parameter, REF is the non-target signal; (2) the residual signal ERR includes K single beam first signals B₁ [symbol] B₂, . . . until B_{K}, performing framing on each single-beam first signal in the residual signal to obtain T frames, and performing Fourier transform on each of the frames to obtain the multi-beam first signal in the frequency domain

$${B}_{k t f}^{( 1 )} ,$$

wherein K is the beam number, k=1, 2, . . . , K, K is the number of beams in the target signal, t is the frame number of the corresponding sub-frame, t=1, 2, . . . , T, f is the frequency point number, f=1, 2, . . . , F.

Preferably, in step S208, dereverberation is performed on the input signals to output a multi-channel second signal in the frequency domain S_{ntf}, wherein n is the microphone number, n=1, 2, . . . , N, N is the number of microphones in the speech acquisition unit, tis the frame number, t=1, 2, . . . , T, f is the frequency point number, f=1, 2, . . . , F.

Preferably, in step S210, the method further includes: performing the signal-to-noise ratio calculation according to the following formula to obtain the signal-to-noise ratio SNR_{ntf} of each channel of the multi-channel third signal:

$$S N {R}_{n t f} = {B}_{n t f}^{( 2 )} / {( {S}_{n t f} - {B}_{n t f}^{( 2 )} )}^{2} ,$$

wherein S_{ntf} is the multi-channel second signal output in the frequency domain by the multi-channel dereverberation module,

$${B}_{n t f}^{( 2 )}$$

is the multi-channel third signal obtained by performing blind source separation on the multi-channel second signal through the blind source separation module, wherein n is the microphone number, n=1, 2, . . . , N, N is the number of microphones in the speech acquisition unit, t is the frame number, t=1, 2, . . . , T, f is the frequency point number, f=1, 2, . . . , F.

Preferably, in step S210, the method further includes: determining the weight of each channel of the multi-channel third signal according to the following formula: G_{ntf}=SNR_{ntf}/(1+SNR_{ntf}), wherein SNR_{ntf} is the signal-to-noise ratio of each third signal, n is the microphone number, n=1, 2, . . . , N, N is the number of microphones in the speech acquisition unit, t is the frame number of the corresponding sub-frame, t=1, 2, . . . , T, f is the frequency point number, f=1, 2, . . . , F.

Preferably, in step S212, the method further comprises: mapping N sets of weights G_{ntf} to K sets of multi-beam first signal

$${B}_{k t f}^{( 1 )}$$

according to the following formula, to obtain the mapped multi-channel frequency-domain fourth signal E, wherein:

$${E}_{m t f} = {G}_{ntf} * {B}_{k t f}^{( 1 )} ,$$

wherein E_{mtf} is the m^{th} frequency-domain channel of the multi-channel frequency domain fourth signal, m=1, 2, . . . , M, M=K*N, K is the number of beams in the target signal, N is the number of microphones in the speech acquisition unit; G_{ntf} is the weight of the n^{th} channel of the multi-channel third signal, n=1, 2, . . . , N;

$${B}_{k t f}^{( 1 )}$$

is k^{th} single beam first signal of the multi-beam first signal, k=1, 2, . . . , K; t is the frame number of the corresponding sub-frame, t=1, 2, . . . , T, f is the frequency point number, f=1, 2, . . . , F. More preferably, in step S12, the method further includes performing an inverse Fourier transform operation on the multi-channel frequency domain fourth signal to obtain a multi-channel time domain fourth signal eₘ, wherein m=1, 2, . . . , M.

Preferably, after step S212, the method further includes: scoring each channel of the multi-channel time-domain fourth signal to obtain scores respectively, determine a Z-channel time-domain fourth signal with scores greater than a wake-up threshold, and determine a time-domain channel with the highest energy of the Z-channel time-domain fourth signal, where Z is greater than or equal to 1; and outputting the time-domain channel with the highest energy; and obtaining the time-domain channel with the highest energy to perform speech recognition and output the recognized speech.

### Specific Embodiment 3

As a specific embodiment of the present disclosure, FIG. 3 shows a schematic diagram of the hardware design of an echo cancellation apparatus according to an embodiment of the present disclosure. The echo cancellation apparatus of the present disclosure may include a speech acquisition module 302, an audio playback module 304, a power amplifier 306, a digital/analog converter (DAC) 308, and a main control chip 310. Exemplarily, the speech acquisition module 302 may be a microphone array composed of multiple microphones. The microphone array can be arranged in a circular shape and placed on top of a smart device (such as a speaker) to facilitate the pickup of the speech commands from the target speaker. Exemplarily, the audio playback module 304 may be a speaker, which may be disposed at the lower middle portion of the column of the smart device (such as a speaker) and face the base. According to the echo cancellation apparatus of the present disclosure, the fixed beamforming module, the blocking matrix module, the cancellation module, the multi-channel dereverberation module, the blind source separation module, the mapping module, the wake-up engine and the recognition engine can all be arranged on the main control chip 310. According to the echo cancellation method of the present disclosure, all steps of the method can be executed by the main control chip 310. The power amplifier 306 and the digital/analog converter DAC 308 according to the embodiment of the present disclosure may be specifically designed as needed, and the present disclosure does not impose any specific limitation thereto.

### Specific Embodiment 4

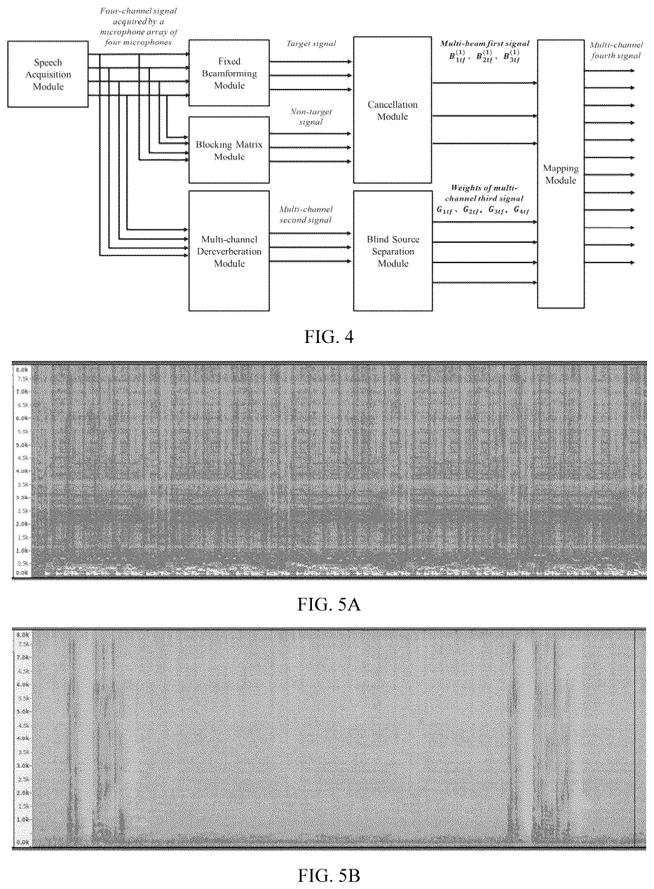

The echo cancellation apparatus and method of the present disclosure are explained below with reference to a specific example shown in FIG. 4.

The speech acquisition module is a microphone array consisting of four microphones, where each microphone samples 512 frames of time-domain speech signals, and a total of four speech signals are acquired. Subsequently, the acquired time-domain speech signal passes through the fixed beamforming module and the blocking matrix module and is input to the cancellation module, wherein the fixed beamforming module sets the number of beams of the output multi-beam first signal to 3, i.e., K=3. The cancellation module uses an adaptive filter to filter and obtain the enhanced time-domain speech signal of the target speaker,

$${B}_{1}^{( 1 )} , {B}_{2}^{( 1 )} , {B}_{3}^{( 1 )} ,$$

the cancellation module further performs framing on the

$${B}_{1}^{( 1 )} , {B}_{2}^{( 1 )} , {B}_{3}^{( 1 )}$$

to obtain T sub-frames and performs Fast Fourier transform (FFT) operation, wherein the Fourier transform operation uses 256 sampling points, that is, F=256. Therefore, the multi-beam first signal output by the cancellation module includes

$${B}_{1}^{( 1 )} , {B}_{2 tf}^{( 1 )} , {B}_{3 tf}^{( 1 )} ,$$

wherein t is the frame number of the corresponding sub-frame, t=1, 2, . . . , T, f is the frequency point number, f=1, 2, . . . , 256.

The multi-channel dereverberation module also receives the four-channel speech signal acquired by the speech acquisition module to obtain signals in the time domain. The multi-channel dereverberation module performs dereverberation processing on the time-domain signals to obtain a multi-channel second signal in the frequency domain, S_{1tf} [symbol] S₂ₜ [symbol] S_{3tf} [symbol] S_{4tf}, wherein t is the frame number of the corresponding sub-frame, t=1, 2, . . . , T, f is the frequency point number, f=1, 2, . . . , 256.

The multi-channel second signal output by the multi-channel dereverberation module in the frequency domain are input to the blind source separation module to obtain the multi-channel third signal obtained by blind source separation,

$${B}_{1}^{( 2 )} , {B}_{2}^{( 2 )} , {B}_{3}^{( 2 )} , {B}_{4}^{( 2 )} .$$

### Each of the

$${B}_{1}^{( 2 )} , {B}_{2}^{( 2 )} , {B}_{3}^{( 2 )} , {B}_{4}^{( 2 )}$$

is also segmented into sub-frames, and Fourier transform operation is performed on each sub-frame to obtain

$${B}_{1 tf}^{( 2 )} , {B}_{2 tf}^{( 2 )} , {B}_{3 t}^{( 2 )} , {B}_{4 tf}^{( 2 )} ,$$

wherein t is the frame number of the corresponding sub-frame, t=1, 2, . . . , T, f is the frequency point number, f=1, 2, . . . , 256.

The blind source separation module further calculates the signal-to-noise ratio of each channel of the multi-channel third signal in the frequency domain by

$${SNR}_{n t f} = {B}_{n t f}^{( 2 )} / {( {S}_{n t f} - {B}_{n t f}^{( 2 )} )}^{2} ,$$

and determines the weight G_{ntf} of each channel of the multi-channel third signal: G_{ntf}=SNR_{ntf}/(1+SNR_{ntf}) wherein SNR_{ntf} is the signal-to-noise ratio of each third signal, nis the microphone number, n=1, 2, . . . , 4, N is the number of microphones in the speech acquisition unit, t is the frame number of the corresponding sub-frame, t=1, 2, . . . , T, f is the frequency point number, f=1, 2, . . . , 256.

The mapping module maps the 4 sets of weights G_{ntf}, (n=1 . . . 4) output by the blind source separation module into 3 sets of multi-beam first signal

$${B}_{k t f}^{( 1 )} ,$$

(k=1 . . . 3), to obtain the mapped multi-channel frequency-domain fourth signal E, wherein:

$${E}_{m t f} = {G}_{ntf} * {B}_{k t f}^{( 1 )} ,$$

thereby realizing the scaling processing of the multi-beam first signal in the frequency domain and obtaining frequency domain enhanced speech data E_{mtf}, wherein m=1, 2, . . . , M, M=K*N (M is 12 in this example), K is the number of beams in the target signal (3 in this example), N is the number of microphones in the speech acquisition unit (4 in this example), M=4*3=12. The specific calculation is: E_{mTF}=G_{nTF}*B_{kTF}. Finally, the mapping module performs inverse Fourier transform on the obtained M=12 frequency-domain signal E_{mtf} to obtain 12 time-domain signals eₘ, (m=1 . . . 12).

Optionally, the time-domain signal can be further input into the wake-up engine and the recognition engine for further speech recognition.

### Specific Embodiment 5

The advantages of the echo cancellation apparatus and method of the present disclosure are further verified by experimental data below.

According to a specific embodiment of the present disclosure, the speech acquisition module adopts a circular six-microphone array, wherein the six microphones are evenly distributed along a circle with a radius of 4 cm. The audio playback unit is a speaker, which is arranged at the center of the circle and is 10 cm away from the plane where the microphone array is located. According to one embodiment of the present disclosure, a speaker is arranged to play music at 85 dB, and a target speaker wakes up the device every 8 seconds and issues a speech wake-up instruction. The energy of the speech wake-up instruction reaching the microphone is 65 dB. FIG. 5A shows original noisy data acquired by the microphone, and FIG. 5B shows clean speech data output by the echo cancellation apparatus designed by the present disclosure. In FIG. 5B, microphone data and speech data obtained by the system designed by the present disclosure are respectively obtained in an acoustic scene of −20 dB. This demonstrates that the system of the present disclosure can effectively eliminate echoes by utilizing the technical solution provided by the present disclosure without a reference loop, and can not only obtain speech with a high signal-to-noise ratio, but also ensure that the distortion of the target speaker's speech is very small.

The above embodiments provide specific operation processes in an illustrative manner, but it should be understood that the protection scope of the present disclosure is not limited thereto.

While various embodiments of aspects of the present disclosure have been described for purposes of this disclosure, they should not be understood as limiting the teachings of the present disclosure to these embodiments. Features disclosed in a specific embodiment are not limited to that embodiment, but can be combined with features disclosed in different embodiments. Furthermore, it should be understood that the method steps described above may be performed sequentially, performed in parallel, combined into fewer steps, split into more steps, combined in ways different than described, and/or omitted. Those skilled in the art should understand that there are many possible alternative implementations and variations, and that various changes and modifications may be made to the above modules and structures without departing from the scope defined by the claims of the present disclosure.

1. An echo cancellation apparatus without a reference loop, comprising:
a fixed beamforming module configured to fix a multi-channel signal acquired by a speech acquisition unit into a plurality of first beams, superimpose the plurality of first beams and output a target signal;
a blocking matrix module configured to input the multi-channel signal acquired by the speech acquisition unit into a blocking matrix for preprocessing to output a non-target signal;
a cancellation module configured to perform cancellation between the target signal and the non-target signal and output a multi-beam first signal;
a multi-channel dereverberation module configured to perform dereverberation on the multi-channel signal acquired by the speech acquisition unit and output a multi-channel second signal;
a blind source separation module configured to perform blind source separation on the multi-channel second signal to output a multi-channel third signal, perform signal-to-noise ratio calculation on each channel of the multi-channel third signal in the frequency domain, and determine a weight of each channel of the multi-channel third signal; and
a mapping module configured to map the weights to the multi-beam first signal and output a mapped multi-channel frequency-domain fourth signal.

2. The echo cancellation apparatus according to claim 1, wherein the cancellation module performing cancellation between the target signal and the non-target signal and outputting a multi-beam first signal comprises:
(1) performing cancellation between the target signal and non-target signal according to a following formula:
$$E R R = MIC - w * R E F ,$$
wherein ERR is a residual signal, MIC is the target signal, w is a filter parameter, REF is the non-target signal;
(2) the residual signal ERR comprises K single beam first signals B₁, B₂, . . . until B_{K}, performing framing on each single-beam first signal in the residual signal to obtain T sub-frames, and performing Fourier transform on each of the sub-frames to obtain the multi-beam first signal in the frequency domain
$${B}_{ktf}^{( 1 )} ,$$
wherein k is the beam number, k=1, 2, . . . , K, K is the number of beams in the target signal, t is the frame number of the corresponding sub-frame, t=1, 2, . . . , T, f is the frequency point number, f=1, 2, . . . , F, wherein F is a number of sampling points of the Fourier transform.

3. The echo cancellation apparatus according to claim 2, wherein the blind source separation module is configured to calculate the signal-to-noise ratio according to the following formula to obtain the signal-to-noise ratio SNR_{ntf} of each channel of the multi-channel third signal:
$${SNR}_{ntf} = {B}_{ntf}^{( 2 )} / {( {S}_{ntf} - {B}_{ntf}^{( 2 )} )}^{2} ,$$
wherein S_{ntf} is the multi-channel second signal output by the multi-channel dereverberation module in the frequency domain,
$${B}_{ntf}^{( 2 )}$$
is the multi-channel third signal obtained by performing blind source separation on the multi-channel second signal through the blind source separation module, wherein n is the microphone number, n=1, 2, . . . , N, N is the number of microphones in the speech acquisition unit, t is the frame number of the corresponding sub-frame, t=1, 2, . . . , T, f is the frequency point number, f=1, 2, . . . , F.

4. The echo cancellation apparatus according to claim 3, wherein the blind source separation module is configured to determine the weight G_{ntf} of each channel of the multi-channel third signal according to the following formula:
$${G}_{ntf} = {SNR}_{ntf} / ( 1 + {SNR}_{ntf} ) ,$$
wherein SNR_{ntf} is the signal-to-noise ratio of each third signal, nis the microphone number, n=1, 2, . . . , N, N is the number of microphones in the speech acquisition unit, t is the frame number of the corresponding sub-frame, t=1, 2, . . . , T, f is the frequency point number, f=1, 2, . . . , F.

5. The echo cancellation apparatus according to claim 4, wherein the mapping module is configured to map N sets of weights G_{ntf} to K sets of multi-beam first signal
$${B}_{ktf}^{( 1 )}$$
according to the following formula, to obtain the mapped multi-channel frequency-domain fourth signal E, wherein:
$${E}_{mtf} = {G}_{ntf} * {B}_{ktf}^{( 1 )} ,$$
wherein E_{mtf} is the m^{th} frequency-domain channel of the multi-channel frequency domain fourth signal, m=1, 2, . . . , M, M=K*N, K is the number of beams in the target signal, N is the number of microphones in the speech acquisition unit; G_{ntf} is the weight of the n^{th} channel of the multi-channel third signal, n=1, 2, . . . , N;
$${B}_{ktf}^{( 1 )}$$
is k^{th} single beam first signal of the multi-beam first signal, k=1, 2, . . . , K; t is the frame number of the corresponding sub-frame, t=1, 2, . . . , T, f is the frequency point number, f=1, 2, . . . , F;
the mapping module is further configured to perform an inverse Fourier transform operation on the multi-channel frequency-domain fourth signal to obtain a multi-channel time-domain fourth signal eₘ, wherein m=1, 2, . . . , M.

6. The echo cancellation apparatus according to claim 5, further comprising a wake-up engine configured to score each channel of the multi-channel time-domain fourth signal to obtain scores respectively, determine a Z-channel time-domain fourth signal with scores greater than a wake-up threshold, and determine a time-domain channel with the highest energy of the Z-channel time-domain fourth signal, where Z is greater than or equal to 1;
the wake-up engine is also configured to output the time-domain channel with the highest energy; and
a recognition engine configured to obtain the time-domain channel with the highest energy from the wake-up engine to perform speech recognition and output the recognized speech.

7. An echo cancellation method without a reference loop, comprising following steps:
fixing a multi-channel signal acquired by a speech acquisition unit into a plurality of first beams, superimposing the plurality of first beams and outputting a target signal;
inputting the multi-channel signal acquired by the speech acquisition unit into a blocking matrix for preprocessing to output a non-target signal;
performing cancellation between the target signal and the non-target signal and outputting a multi-beam first signal;
performing dereverberation on the multi-channel signal acquired by the speech acquisition unit, and outputting a multi-channel second signal;
performing blind source separation on the multi-channel second signal to obtain a multi-channel third signal, performing signal-to-noise ratio calculation on each channel of the multi-channel third signal in the frequency domain, and determining a weight of each channel of the multi-channel third signal; and
mapping the weights to the multi-beam first signal and outputting a mapped multi-channel frequency-domain fourth signal.

8. The echo cancellation method according to claim 7, wherein the step of performing cancellation between the target signal and the non-target signal and outputting the multi-beam first signal comprises:
(1) performing cancellation between the target signal and the non-target signal according to a following formula:
$$ERR = MIC - w * REF ,$$
wherein ERR is a residual signal, MIC is the target signal, w is a filter parameter, REF is the non-target signal;
(2) the residual signal ERR comprises K single beam first signals B₁ [symbol] B₂, . . . until B_{K}, performing framing on each single-beam first signal in the residual signal to obtain T sub-frames, and performing Fourier transform on each of the sub-frames to obtain the multi-beam first signal in the frequency domain
$${B}_{ktf}^{( 1 )} ,$$
wherein k is the beam number, k=1, 2, . . . , K, K is the number of beams in the target signal, t is the frame number of the corresponding sub-frame, t=1, 2, . . . , T, f is the frequency point number, f=1, 2, . . . , F, wherein F is a number of sampling points of the Fourier transform.

9. The echo cancellation method according to claim 8, comprising performing the signal-to-noise ratio calculation according to a following formula to obtain the signal-to-noise ratio SNR_{ntf} of each channel of the multi-channel third signal:
$${SNR}_{ntf} = {B}_{ntf}^{( 2 )} / {( {S}_{ntf} - {B}_{ntf}^{( 2 )} )}^{2} ,$$
wherein S_{ntf} is the multi-channel second signal output by the multi-channel dereverberation module in the frequency domain,
$${B}_{ntf}^{( 2 )}$$
is the multi-channel third signal obtained by performing blind source separation on the multi-channel second signal through the blind source separation module, wherein n is the microphone number, n=1, 2, . . . , N, N is the number of microphones in the speech acquisition unit, t is the frame number of the corresponding sub-frame, t=1, 2, . . . , T, f is the frequency point number, f=1, 2, . . . , F.

10. The echo cancellation method according to claim 9, comprising: determining a weight of each channel of the multi-channel third signal according to the following formula:
$${G}_{ntf} = {SNR}_{ntf} / ( 1 + {SNR}_{ntf} ) ,$$
wherein SNR_{ntf} is the signal-to-noise ratio of each third signal, n is the microphone number, n=1, 2, . . . , N, N is the number of microphones in the speech acquisition unit, t is the frame number of the corresponding sub-frame, t=1, 2, . . . , T, f is the frequency point number, f=1, 2, . . . , F.

11. The echo cancellation method according to claim 10, comprising: mapping N sets of weights G_{ntf} to K sets of multi-beam first signal
$${B}_{ktf}^{( 1 )}$$
according to a following formula, to obtain the mapped multi-channel frequency-domain fourth signal E, wherein:
$${E}_{mtf} = {G}_{ntf} * {B}_{ktf}^{( 1 )} ,$$
wherein E_{mtf} is the m^{th} frequency-domain channel of the multi-channel frequency domain fourth signal, m=1, 2, . . . , M, M=K*N, K is the number of beams in the target signal, N is the number of microphones in the speech acquisition unit; G_{ntf} is the weight of the n^{th} channel of the multi-channel third signal, n=1, 2, . . . , N;
$${B}_{ktf}^{( 1 )}$$
is k^{th} single beam first signal of the multi-beam first signal, k=1, 2, . . . , K; t is the frame number of the corresponding sub-frame, t=1, 2, . . . , T, f is the frequency point number, f=1, 2, . . . , F;
performing an inverse Fourier transform operation on the multi-channel frequency-domain fourth signal to obtain a multi-channel time-domain fourth signal eₘ, wherein m=1, 2, . . . , M.

12. The echo cancellation method according to claim 11, further comprising: after outputting the mapped multi-channel frequency-domain fourth signal, scoring each channel of the multi-channel time-domain fourth signal to obtain scores respectively, determine a Z-channel time-domain fourth signal with scores greater than a wake-up threshold, and determine a time-domain channel with the highest energy of the Z-channel time-domain fourth signal, where Z is greater than or equal to 1; and outputting the time-domain channel with the highest energy; and
obtaining the time-domain channel with the highest energy to perform speech recognition and output the recognized speech.
